(19) United States
(12) Patent Application Publication
(10) Pub. No.: US 2007/0118373 A1
(43) Pub. Date: May 24, 2007

(54) SYSTEM AND METHOD FOR GENERATING CLOSED CAPTIONS

(76) Inventors: Gerald Bowden Wise, Clifton Park, NY (US); Louis John Hoebel, Burnt Hills, NY (US); John Michael Lizzi, Wilton, NY (US); Wei Chai, Niskayuna, NY (US); Helena Goldfarb, Niskayuna, NY (US); Anil Abraham, New York, NY (US); Richard Louis Zinser, Niskayuna, NY (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/538,936

(22) Filed: Oct. 5, 2006

Related U.S. Application Data
(63) Continuation-in-part of application No. 11/287,556, filed on Nov. 23, 2005.

(51) Int. Cl. G10L 15/26

(52) U.S. Cl. 704/235

(57) ABSTRACT

A system for generating closed captions from an audio signal includes an audio pre-processor configured to correct one or more predetermined undesirable attributes from an audio signal and to output one or more speech segments. The system also includes a speech recognition module configured to generate from the one or more speech segments one or more text transcripts and a post processor configured to provide at least one pre-selected modification to the text transcripts. Further included is an encoder configured to broadcast modified text transcripts corresponding to the speech segments as closed captions.

### CROSS REFERENCE TO RELATED APPLICATION

This application is a continuation in part of U.S. patent application Ser. No. 11/287,556, filed Nov. 23, 2005, and entitled “System and Method for Generating Closed Captions.”

### BACKGROUND

The invention relates generally to generating closed captions and more particularly to a system and method for automatically generating closed captions using speech recognition.

Closed captioning is the process by which an audio signal is translated into visible textual data. The visible textual data may then be made available for use by a hearing-impaired audience in place of the audio signal. A caption decoder embedded in televisions or video recorders generally separates the closed caption text from the audio signal and displays the closed caption text as part of the video signal.

Speech recognition is the process of analyzing an acoustic signal to produce a string of words. Speech recognition is generally used in hands-busy or eyes-busy situations such as when driving a car or when using small devices like personal digital assistants. Some common applications that use speech recognition include human-computer interactions, multi-modal interfaces, telephony, dictation, and multimedia indexing and retrieval. The speech recognition requirements for the above applications, in general, vary, and have differing quality requirements. For example, a dictation application may require near real-time processing and a low word error rate text transcription of the speech, whereas a multimedia indexing and retrieval application may require speaker independence and much larger vocabularies, but can accept higher word error rates.

### BRIEF DESCRIPTION

In accordance with an embodiment of the present invention, a system for generating closed captions from an audio signal comprises an audio pre-processor configured to correct one or more predetermined undesirable attributes from an audio signal and to output one or more speech segments. The system also comprises a speech recognition module configured to generate from the one or more speech segments one or more text transcripts and a post processor configured to provide at least one pre-selected modification to the text transcripts. Further included is an encoder configured to broadcast modified text transcripts corresponding to the speech segments as closed captions.

In another embodiment, a method of generating closed captions from an audio signal comprises correcting one or more predetermined undesirable attributes from the audio signal and outputting one or more speech segments; generating from the one or more speech segments one or more text transcripts; providing at least one pre-selected modification to the text transcripts; and broadcasting modified text transcripts corresponding to the speech segments as closed captions.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a system for generating closed captions in accordance with one embodiment of the invention;

FIG. 2 illustrates a system for identifying an appropriate context associated with text transcripts, using context-based models and topic-specific databases in accordance with one embodiment of the invention;

FIG. 3 illustrates a process for automatically generating closed captioning text in accordance with an embodiment of the present invention;

FIG. 4 illustrates another embodiment of a system for generating closed captions;

FIG. 5 illustrates a process for automatically generating closed captioning text in accordance with another embodiment of the present invention;

FIG. 6 illustrates another embodiment of a system for generating closed captions; and

FIG. 7 illustrates a further embodiment of a system for generating closed captions.

### DETAILED DESCRIPTION OF PREFERRED EMBODIMENTS

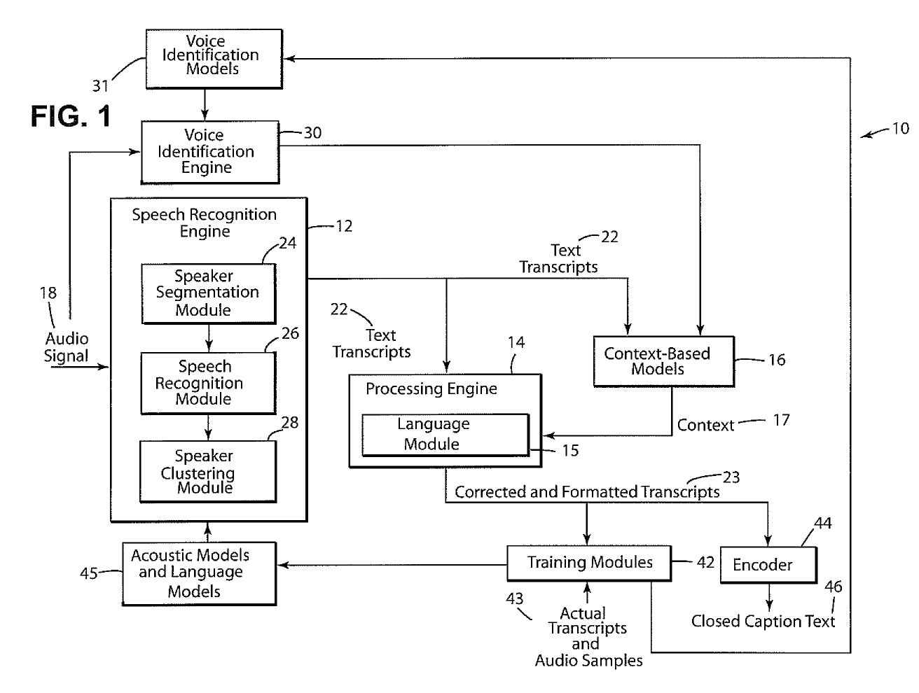

FIG. 1 is an illustration of a system 10 for generating closed captions in accordance with one embodiment of the invention. As shown in FIG. 1, the system 10 generally includes a speech recognition engine 12, a processing engine 14 and one or more context-based models 16. The speech recognition engine 12 receives an audio signal 18 and generates text transcripts 22 corresponding to one or more speech segments from the audio signal 18. The audio signal may include a signal conveying speech from a news broadcast, a live or recorded coverage of a meeting or an assembly, or from scheduled (live or recorded) network or cable entertainment. In certain embodiments, the speech recognition engine 12 may further include a speaker segmentation module 24, a speech recognition module 26 and a speaker-clustering module 28. The speaker segmentation module 24 converts the incoming audio signal 18 into speech and non-speech segments. The speech recognition module 26 analyzes the speech in the speech segments and identifies the words spoken. The speaker-clustering module 28 analyzes the acoustic features of each speech segment to identify different voices, such as, male and female voices, and labels the segments in an appropriate fashion.

The context-based models 16 are configured to identify an appropriate context 17 associated with the text transcripts 22 generated by the speech recognition engine 12. In a particular embodiment, and as will be described in greater detail below, the context-based models 16 include one or more topic-specific databases to identify an appropriate context 17 associated with the text transcripts. In a particular embodiment, a voice identification engine 30 may be coupled to the context-based models 16 to identify an appropriate context of speech and facilitate selection of text for output as captioning. As used herein, the “context” refers to the speaker as well as the topic being discussed. Knowing who is speaking may help determine the set of possible topics (e.g., if the weather anchor is speaking, topics will be most likely limited to weather forecasts, storms, etc.). In addition to identifying speakers, the voice identification engine 30 may also be augmented with non-speech models to help identify sounds from the environment or setting (explosion, music, etc.). This information can also be utilized to help identify topics. For example, if an explosion sound is identified, then the topic may be associated with war or crime.

The voice identification engine 30 may further analyze the acoustic feature of each speech segment and identify the specific speaker associated with that segment by comparing the acoustic feature to one or more voice identification models 31 corresponding to a set of possible speakers and determining the closest match based upon the comparison. The voice identification models may be trained offline and loaded by the voice identification engine 30 for real-time speaker identification. For purposes of accuracy, a smoothing/filtering step may be performed before presenting the identified speakers to avoid instability (generally caused due to unrealistic high frequency of changing speakers) in the system.

The processing engine 14 processes the text transcripts 22 generated by the speech recognition engine 12. The processing engine 14 includes a natural language module 15 to analyze the text transcripts 22 from the speech recognition engine 12 for word error correction, named-entity extraction, and output formatting on the text transcripts 22. Word error correction involves use of a statistical model (employed with the language model) built off line using correct reference transcripts, and updates thereof, from prior broadcasts. A word error correction of the text transcripts may include determining a word error rate corresponding to the text transcripts. The word error rate is defined as a measure of the difference between the transcript generated by the speech recognizer and the correct reference transcript. In some embodiments, the word error rate is determined by calculating the minimum edit distance in words between the recognized and the correct strings. Named entity extraction processes the text transcripts 22 for names, companies, and places in the text transcripts 22. The names and entities extracted may be used to associate metadata with the text transcripts 22, which can subsequently be used during indexing and retrieval. Output formatting of the text transcripts 22 may include, but is not limited to, capitalization, punctuation, word replacements, insertions and deletions, and insertions of speaker names.

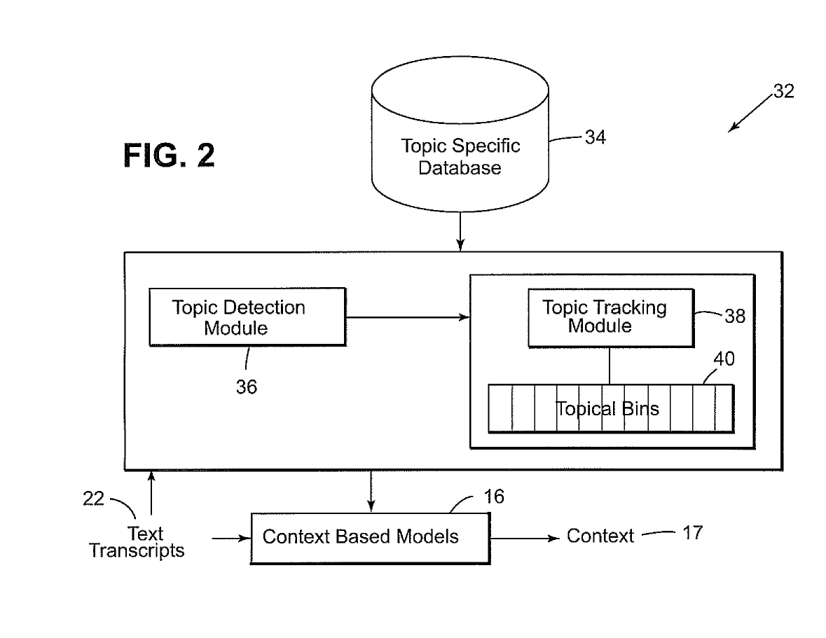

FIG. 2 illustrates a system for identifying an appropriate context associated with text transcripts, using context-based models and topic-specific databases in accordance with one embodiment of the invention. As shown in FIG. 2, the system 32 includes a topic-specific database 34. The topic-specific database 34 may include a text corpus, comprising a large collection of text documents. The system 32 further includes a topic detection module 36 and a topic tracking module 38. The topic detection module 36 identifies a topic or a set of topics included within the text transcripts 22. The topic tracking module 38 identifies particular text-transcripts 22 that have the same topic(s) and categorizes stories on the same topic into one or more topical bins 40.

Referring to FIG. 1, the context 17 associated with the text transcripts 22 identified by the context based models 16 is further used by the processing engine 16 to identify incorrectly recognized words and identify corrections in the text transcripts, which may include the use of natural language techniques. In a particular example, if the text transcripts 22 include a phrase, “she spotted a sale from far away” and the topic detection modulel6 identifies the topic as a “beach” then the context based models 16 will correct the phrase to “she spotted a sail from far away”.

In some embodiments, the context-based models 16 analyze the text transcripts 22 based on a topic specific word probability count in the text transcripts. As used herein, the “topic specific word probability count” refers to the likelihood of occurrence of specific words in a particular topic wherein higher probabilities are assigned to particular words associated with a topic than with other words. For example, as will be appreciated by those skilled in the art, words like “stock price” and “DOW industrials” are generally common in a report on the stock market but not as common during a report on the Asian tsunami of December 2004, where words like “casualties,” and “earthquake” are more likely to occur. Similarly, a report on the stock market may mention “Wall Street” or “Alan Greenspan” while a report on the Asian tsunami may mention “Indonesia” or “Southeast Asia”. The use of the context-based models 16 in conjunction with the topic-specific database 34 improves the accuracy of the speech recognition engine 12. In addition, the context-based models 16 and the topic-specific databases 34 enable the selection of more likely word candidates by the speech recognition engine 12 by assigning higher probabilities to words associated with a particular topic than other words.

Referring to FIG. 1, the system 10 further includes a training module 42. In accordance with one embodiment, the training module 42 manages acoustic models and language models 45 used by the speech recognition engine 12. The training module 42 augments dictionaries and language models for speakers and builds new speech recognition and voice identification models for new speakers. The training manager 42 utilizes audio samples to build acoustic models and voice id models for new speakers. The training module 42 uses actual transcripts and audio samples 43, and other appropriate text documents, to identify new words and frequencies of words and word combinations based on an analysis of a plurality of text transcripts and documents and updates the language models 45 for speakers based on the analysis. As will be appreciated by those skilled in the art, acoustic models are built by analyzing many audio samples to identify words and sub-words (phonemes) to arrive at a probabilistic model that relates the phonemes with the words. In a particular embodiment, the acoustic model used is a Hidden Markov Model (HMM). Similarly, language models may be built from many samples of text transcripts to determine frequencies of individual words and sequences of words to build a statistical model. In a particular embodiment, the language model used is an N-grams model. As will be appreciated by those skilled in the art, the N-grams model uses a sequence of N words in a sequence to predict the next word, using a statistical model.

An encoder 44 broadcasts the text transcripts 22 corresponding to the speech segments as closed caption text 46. The encoder 44 accepts an input video signal, which may be analog or digital. The encoder 44 further receives the corrected and formatted transcripts 23 from the processing engine 14 and encodes the corrected and formatted transcripts 23 as closed captioning text 46. The encoding may be performed using a standard method such as, for example, using line 21 of a television signal. The encoded, output video signal may be subsequently sent to a television, which decodes the closed captioning text 46 via a closed caption decoder. Once decoded, the closed captioning text 46 may be overlaid and displayed on the television display.

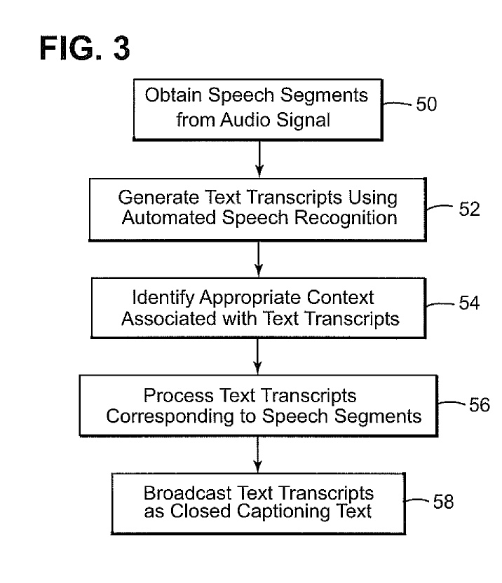

FIG. 3 illustrates a process for automatically generating closed captioning text, in accordance with one embodiment of the present invention. In step 50, one or more speech segments from an audio signal are obtained. The audio signal 18 (FIG. 1) may include a signal conveying speech from a news broadcast, a live or recorded coverage of a meeting or an assembly, or from scheduled (live or recorded) network or cable entertainment. Further, acoustic features corresponding to the speech segments may be analyzed to identify specific speakers associated with the speech segments. In one embodiment, a smoothing/filtering operation may be applied to the speech segments to identify particular speakers associated with particular speech segments. In step 52, one or more text transcripts corresponding to the one or more speech segments are generated. In step 54, an appropriate context associated with the text transcripts 22 is identified. As described above, the context 17 helps identify incorrectly recognized words in the text transcripts 22 and helps the selection of corrected words. Also, as mentioned above, the appropriate context 17 is identified based on a topic specific word probability count in the text transcripts. In step 56, the text transcripts 22 are processed. This step includes analyzing the text transcripts 22 for word errors and performing corrections. In one embodiment, the text transcripts 22 are analyzed using a natural language technique. In step 58, the text transcripts are broadcast as closed captioning text.

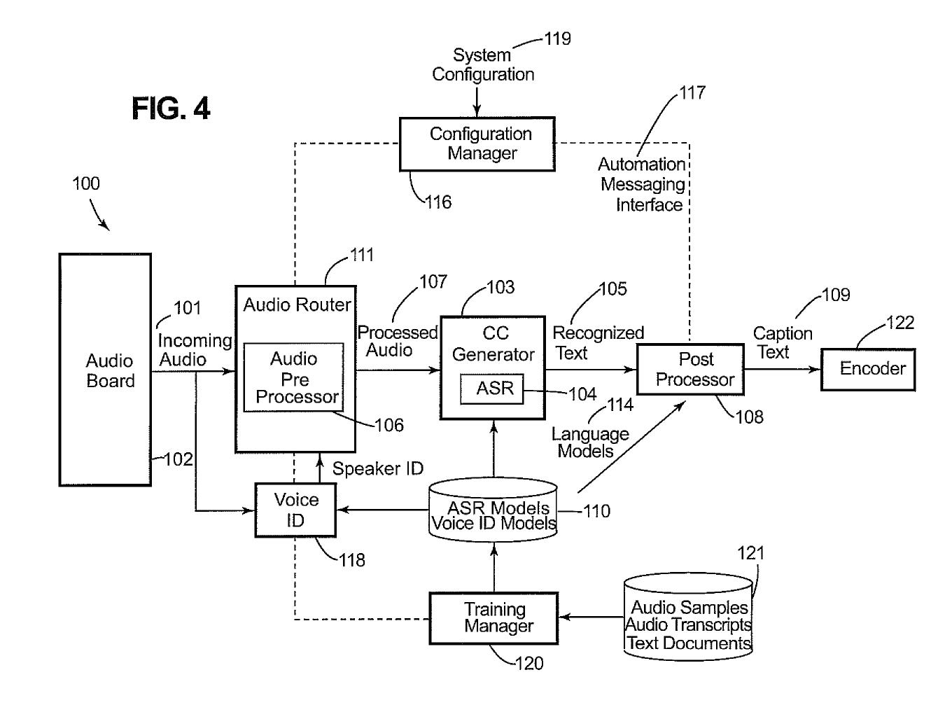

Referring now to FIG. 4, another embodiment of a closed caption system in accordance with the present invention is shown generally at 100. The closed caption system 100 receives an audio signal 101, for example, from an audio board 102, and comprises in this embodiment, a closed captioned generator 103 with speech recognition module 104 and an audio pre-processor 106. Also, provided in this embodiment is an audio router 111 that functions to route the incoming audio signal 101, through the audio-pre-processor 106, and to the speech recognition module 104 (sometimes referred to herein as ASR 104). The recognized text 105 is then routed to a post processor 108. As described above, the audio signal 101 may comprise a signal conveying speech from a live or recorded event such as a news broadcast, a meeting or entertainment broadcast. The audio board 102 may be any known device that has one or more audio inputs, such as from microphones, and may combine the inputs to produce a single output audio signal 101, although, multiple outputs are contemplated herein as described in more detail below.

The speech recognition module 104 may be similar to the speech recognition module 26, described above, and generates text transcripts from speech segments. In one optional embodiment, the speech recognition module 104 may utilize one or more speech recognition engines that may be speaker-dependent or speaker-independent. In this embodiment, the speech recognition module 104 utilizes a speaker-dependent speech recognition engine that communicates with a database 110 that includes various known models that the speech recognition module uses to identify particular words. Output from the speech recognition module 104 is recognized text 105.

In accordance with this embodiment, the audio pre-processor 106 functions to correct one or more undesirable attributes from the audio signal 101 and to provide speech segments that are, in turn, fed to the speech recognition module 104. For example, the pre-processor 106 may provide breath reduction and extension, zero level elimination, voice activity detection and crosstalk elimination. In one aspect, the audio pre-processor is configured to specifically identify breaths in the audio signal 101 and attenuate them so that the speech recognition engine can more easily detect speech. Also, where the duration of the breath is less than a time interval set by the speech recognition module for identifying individual words, the duration of the breath is extended to match that interval.

To provide zero level elimination, occurrences of zero-level energy with the audio signal 101 are replaced with a predetermined low level of background noise. This is to facilitate the identification of speech and non-speech boundaries by the speech recognition engine.

Voice activity detection (VAD) comprises detecting speech segments within the source audio input and filters out the non-speech segments. As a consequence of this, segments that do not contain speech (e.g., stationary background noise) are also identified. These non-speech segments may be treated like breath noise (attenuated or extended, as necessary). Note the VAD algorithms and breath-specific algorithms generally do not identify the same type of non-speech signal. One embodiment uses a VAD and a breath detection algorithm in parallel to identify non-speech segments of the input signal.

The closed captioning system may be configured to receive audio input from multiple audio sources (e.g., microphones or devices). The audio from each audio source is connected to an instance of the speech recognition engine. For example, on a studio set where several speakers are conversing, any given microphone will not only pick up the its own speaker, but will also pick up other speakers. Cross talk elimination is employed to remove all other speakers from each individual microphone line, thereby capturing speech from a sole individual. This is accomplished by employing multiple adaptive filters. More details of a suitable system and method of cross talk elimination for use in the practice of the present embodiment are available in U.S. Pat. No. 4,649,505, to Zinser Jr. et al, the contents of which are hereby incorporated herein by reference to the extent necessary to make and practice the present invention.

Optionally, the audio pre-processor 106 may include a speaker segmentation module 24 (FIG. 1) and a speaker-clustering module 28 (FIG. 1) each of which are described above. Processed audio 107 is output from the audio pre-processor 106.

The post processor 108 functions to provide one or more modifications to the text transcripts generated by the speech recognition module 104. These modifications may comprise use of language models 114, similar to that employed with the language models 45 described above, which are provided for use by the post processor 108 in correcting the text transcripts as described above for context, word error correction, and/or vulgarity cleansing. In addition, the underlying language models, which are based on topics such as weather, traffic and general news, also may be used by the post processor 108 to help identify modifications to the text. The post processor may also provide for smoothing and interleaving of captions by sending text to the encoder in a timely manner while ensuring that the segments of text corresponding to each speaker are displayed in an order that closely matches or preserves the order actually spoken by the speakers. Captioned text 109 is output by the post processor 108.

A configuration manager 116 is provided which receives input system configuration 119 and communicates with the audio pre-processor 106, the post processor 108, a voice identification module 118 and training manager 120. The configuration manager 116 may function to perform dynamic system configuration to initialize the system components or modules prior to use. In this embodiment, the configuration manager 116 is also provided to assist the audio pre-processor, via the audio router 111, by initializing the mapping of audio lines to speech recognition engine instances and to provide the voice identification module 118 with the a set of statistical models or voice identification models 110 via training manager 120. Also, the configuration manager controls the start-up and shutdown of each component module it communicates with and may interface via an automation messaging interface (AMI) 117.

It will be appreciated that the voice identification module 118 may be similar to the voice identification engine 30 described above, and may access database or other shared storage 110 for voice identification models.

The training manager 120 is provided in an optional embodiment and functions similar to the training modules 42 described above via input from storage 121.

An encoder 122 is provided which functions similar to the encoder 44 described above.

In operation of the present embodiment, the audio signal 101 received from the audio board 102 is communicated to the audio pre-processor 106 where one or more predetermined undesirable attributes are removed from the audio signal 101 and one or more speech segments is output to the speech recognition module 104. Thereafter, one or more text transcripts are generated by the speech recognition module 104 from the one or more speech segments. Next, the post processor 108 provides at least one pre-selected modification to the text transcripts and finally, the modified text transcripts, corresponding to the speech segments, are broadcast as closed captions by the encoder 122. Prior to this process the configuration manager configures, initializes, and starts up each module of the system.

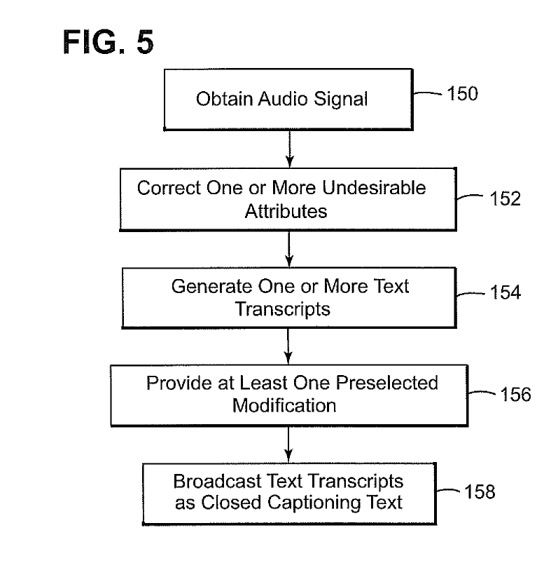

FIG. 5 illustrates another embodiment of a process for automatically generating closed captioning text. As shown, in step 150, an audio signal is obtained. In step 152, one or more predetermined undesirable attributes are removed from the audio signal and one or more speech segments are generated. The one or more predetermined undesirable attributes may comprise at least one of breath identification, zero level elimination, voice activity detection and crosstalk elimination. In step 154, one or more text transcripts corresponding to the one or more speech segments are generated. In step 156, at least one pre-selected modification is made to the one or more text transcripts. The at least one pre-selected modification to the text transcripts may comprise at least one of context, error correction, vulgarity cleansing, and smoothing and interleaving of captions. In step 158, the modified text transcripts are broadcast as closed captioning text. The method may further comprise identifying specific speakers associated with the speech segments and providing an appropriate individual speaker model (not shown in FIG. 5).

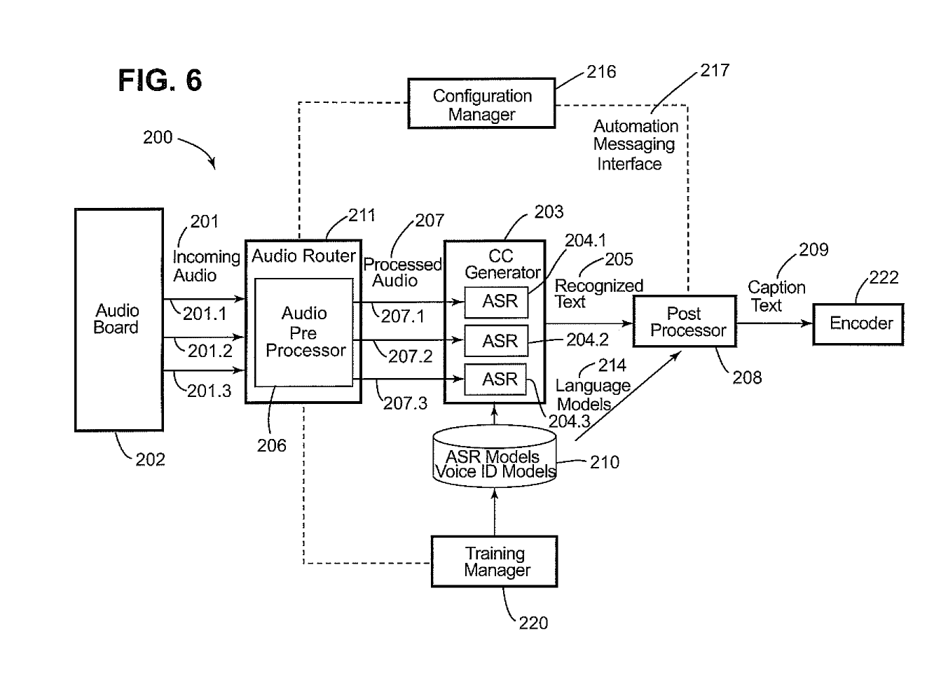

As illustrated in FIG. 6, another embodiment of a closed caption system in accordance with the present invention is shown generally at 200. The closed caption system 200 is generally similar to that of system 100 (FIG. 4) and thus like components are labeled similarly, although, preceded by a two rather than a one. In this embodiment, multiple outputs 201.1, 201.2, 201.3 of incoming audio 201 are shown which are communicated to the audio router 211. Thereafter processed audio 207 is communicated via lines 207.1, 207.2, 207.3 to speech recognition modules 204.1, 204.2, 204.3. This is advantageous where multiple tracks of audio are desired to be separately processed, such as with multiple speakers.

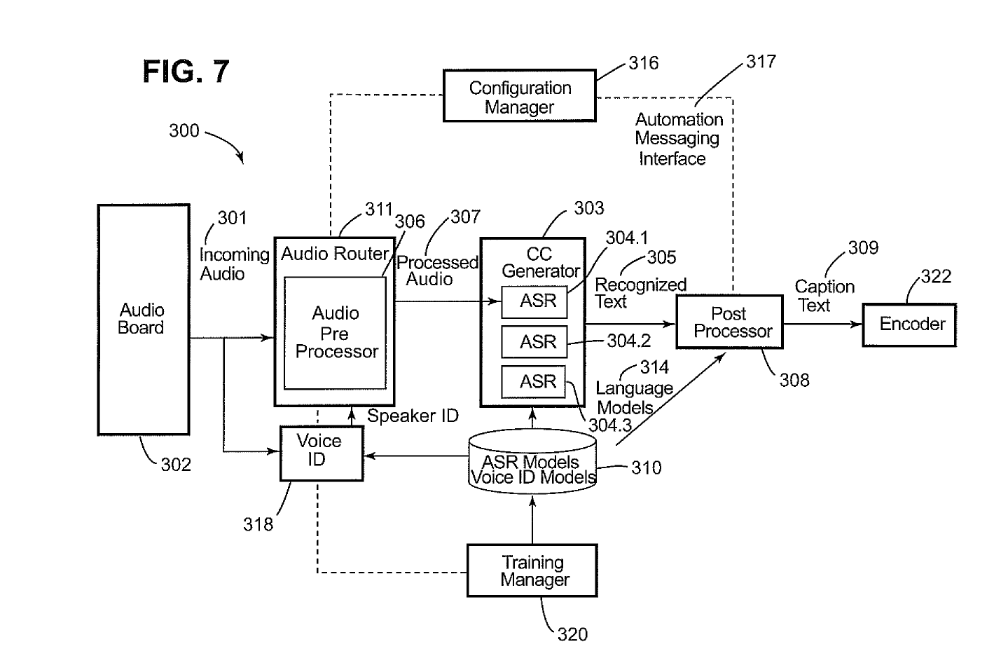

As illustrated in FIG. 7, another embodiment of a closed caption system in accordance with the present invention is shown generally at 300. The closed caption system 300 is generally similar to that of system 200 (FIG. 6) and thus like components are labeled similarly, although, preceded by a three rather than a two. In this embodiment, multiple speech recognition modules 304.1, 304.2 and 304.3 are provided to enable incoming audio to be routed to the appropriate speech recognition engine (speaker independent or speaker dependent).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A system for generating closed captions from an audio signal, the system comprising:
an audio pre-processor configured to correct one or more predetermined undesirable attributes from an audio signal and to output one or more speech segments;
a speech recognition module configured to generate from the one or more speech segments one or more modified text transcripts;
a post processor configured to provide at least one pre-selected modification to the text transcripts; and
an encoder configured to broadcast modified text transcripts corresponding to the speech segments as closed captions.

2. The system of claim 1, further comprising a configuration manager in communication with the audio pre-processor, the speech recognition module, and the post processor and configured to perform at least one of dynamic system configuration, system initialization, and system shutdown.

3. The system of claim 2, further comprising a voice identification module configured to analyze acoustic features corresponding to the speech segments to identify one or more specific speakers associated with the speech segments, the voice identification module being in communication with the pre-processor and the configuration manager and wherein the configuration manager provides an appropriate individual speaker model for use by the speech recognition module based on input from the voice identification module.

4. The system of claim 2, further comprising one or more language models and wherein the configuration manager communicates with the language models and the post processor for analyzing the text transcripts and applying the appropriate language model.

5. The system of claim 4, wherein the one or more language models comprise at least one of weather, traffic and general news.

6. The system of claim 1, wherein the one or more predetermined undesirable attributes corrected by the audio pre-processor comprises at least one of breath identification, zero level elimination, voice activity detection and crosstalk elimination.

7. The system of claim 6, wherein breath identification comprises attenuation of breaths in the audio signal and extension of the breaths determined to be less than a time interval set by the speech recognition module.

8. The system of claim 6, wherein zero level elimination comprises addition of background noise.

9. The system of claim 6, wherein voice activity detection comprises a filter for removing non-speech portions of the audio signal.

10. The system of claim 6, wherein crosstalk elimination comprises a filter for removing speakers other than a speaker of interest in the audio signal.

11. The system of claim 1, wherein the at least one pre-selected modification to the text transcripts provided by the post processor comprises at least one of context, error correction, vulgarity cleansing, and smoothing and interleaving of captions.

12. The system of claim 11, further comprising one or more context-based models in communication with the post processor and configured to identify an appropriate context associated with the text transcripts and wherein the configuration manager connects an appropriate language model based on an associated context identified by the context-based models.

13. The system of claim 11, wherein error correction comprises word error correction.

14. The system of claim 11, wherein the smoothing and interleaving of captions comprises sending text to the encoder in a timely manner while ensuring that the segments of text corresponding to each speaker are displayed in an order that matches or preserves the order actually spoken by the speakers.

15. The system of claim 12, wherein the context-based models include one or more topic-specific databases for identifying an appropriate context associated with the text transcripts.

16. The system of claim 12, wherein the context-based models are adapted to identify the appropriate context based on a topic specific word probability count in the text transcripts corresponding to the speech segments.

17. The system of claim 1, wherein the speech recognition module is coupled to a training module, wherein the training module is configured to augment dictionaries and language models for one or more speakers by analyzing actual transcripts and building additional speech recognition and voice identification models.

18. The system of claim 17, wherein the training module is configured to manage acoustic and language models used by the speech recognition engine and voice identification models used by the voice identification engine.

19. A method of generating closed captions from an audio signal, the method comprising:
correcting one or more predetermined undesirable attributes from the audio signal and outputting one or more speech segments;
generating from the one or more speech segments one or more text transcripts;
providing at least one pre-selected modification to the text transcripts; and
broadcasting modified text transcripts corresponding to the speech segments as closed captions.

20. The method of claim 19, further comprising performing real-time system configuration.

21. The method of claim 19, further comprising:
identifying one or more specific speakers associated with the speech segments; and
providing an appropriate individual speaker model.

22. The method of claim 19, wherein the one or more predetermined undesirable attributes comprises at least one of breath identification, zero level elimination, voice activity detection and crosstalk elimination.

23. The system of claim 19, wherein the at least one pre-selected modification to the text transcripts comprises at least one of context, error correction, vulgarity cleansing, and smoothing and interleaving of captions.
